(19) United States
(12) Patent Application Publication
(10) Pub. No.: US 2025/0360589 A1
(43) Pub. Date: Nov. 27, 2025

(54) METHOD AND MECHANICAL ARRANGEMENT FOR PRODUCING A PROFILE ON A PLASTICALLY DEFORMABLE WORKPIECE BY AXIAL FORMING

(71) Applicant: FELSS Systems GmbH, Koenigsbach-Stein (DE)

(72) Inventors: Alexander KEUERLEBER, Neulingen (DE); Aaron COMBE, Oelbronn (DE); Joerg WACHTER, Keltern (DE); Max Olaf JANDT, Keltern (DE); Serjosha HEINRICHS, Oberderdingen (DE)

(73) Assignee: FELSS Systems GmbH, Koenigsbach-Stein (DE)

(21) Appl. No.: 19/192,504

(22) Filed: Apr. 29, 2025

(30) Foreign Application Priority Data
May 27, 2024 (EP) 24178183.0

(51) Int. Cl. B23Q 15/12

(52) U.S. Cl. CPC B23Q 15/12

(57) ABSTRACT

In the context of a method for producing a profile on a plastically deformable, preferably cylindrical, workpiece by axial forming, a relative movement between a shaping tool profile provided on a forming tool and the workpiece to be formed is carried out during a forming process in order to produce a workpiece-side profile having a workpiece-side profile length. During the relative movement between the shaping tool profile and the workpiece to be formed, an oscillating relative movement between the shaping tool profile and the workpiece to be formed is created, in which a forming stroke and a return stroke in the opposite direction to the forming stroke are alternately carried out. The forming process in progress is varied with respect to the oscillating relative movement. A mechanical arrangement is designed to carry out the aforementioned method.

### CROSS REFERENCE TO RELATED APPLICATIONS

Applicant claims priority under 35 U.S.C. § 119 of European Application No. 24178183.0 filed May 27, 2024, the disclosure of which is incorporated by reference.

### BACKGROUND OF THE INVENTION

### 1. Field of the Invention

The invention relates to a method for producing a workpiece-side profile on a plastically deformable, preferably cylindrical, workpiece by axial forming,
wherein a forming process is carried out, during which a relative movement between a shaping tool profile provided on a forming tool and the workpiece to be formed is carried out to produce the workpiece-side profile with a workpiece-side profile length,
wherein, when the forming process is in progress,
   an oscillating relative movement between the shaping tool profile and the workpiece (2) to be formed is carried out during the relative movement between the shaping tool profile and the workpiece (2) to be formed, in which oscillating relative movement a forming stroke and a return stroke in the opposite direction to the forming stroke are alternately carried out,
   the shaping tool profile produces the workpiece-side profile on the workpiece (2) with a partial length of the workpiece-side profile length (L) during the forming stroke of the oscillating relative movement, and
   the shaping tool profile moves during the return stroke of the oscillating relative movement along at least part of the partial length of the workpiece-side profile length (L) produced during the preceding forming stroke.

The invention also relates to a mechanical arrangement for producing a workpiece-side profile on a plastically deformable, preferably cylindrical, workpiece by axial forming, having a forming machine which has a forming drive designed to carry out, during a forming process. A relative movement between a shaping tool profile provided on a forming tool of the forming machine and a workpiece to be formed, preferably a cylindrical workpiece, in order to produce a workpiece-side profile having a workpiece-side profile length,
wherein a programmable numerical drive controller is provided for the forming drive and is designed to control the forming drive by control parameters being storable in the drive controller, on the basis of which parameters an oscillating relative movement between the shaping tool profile and the workpiece to be formed is carried out when the forming process is in progress when the shaping tool profile and the workpiece to be formed move relative to one another, in which oscillating relative movement a forming stroke and a return stroke in the opposite direction to the forming stroke are alternately carried out,
wherein the shaping tool profile produces the workpiece-side profile on the workpiece with a partial length of the workpiece-side profile length during the forming stroke of the oscillating relative movement, and, wherein the shaping tool profile moves during the return stroke of the oscillating relative movement along at least part of the partial length of the workpiece-side profile length produced during the preceding forming stroke.

### 2. Description of the Related Art

Axial forming is an extrusion process. In extrusion, a forming tool exerts a compressive force, on a workpiece to be formed, that is of such a size that the yield point of the workpiece material is exceeded. For this purpose, the forming tool and the workpiece to be formed act upon each other with a feed force.

Prior art of the type in question is disclosed in DE 197 35 486 A1.

In the prior art, a workpiece to be formed and a forming die sitting on the workpiece are moved against one another along a feed axis. Due to the associated impact of the forming die on the workpiece, the material of the workpiece begins to flow, and, during an axial relative movement of the forming die and the workpiece along the feed axis, the workpiece is formed by the forming die. The relative movement of the forming die and the workpiece is carried out as a non-uniform movement. A frequency generating device causes the forming die and the workpiece to be formed to perform an oscillating relative movement, during which they alternately move towards and away from one another until the workpiece is formed over a predetermined forming length. The parameters of the oscillating forming movement are determined before the forming process starts and remain unchanged during the forming process.

### SUMMARY OF THE INVENTION

The object of the present invention is to provide a method and a mechanical arrangement that achieves processing results with improved quality compared to the prior art.

According to the invention, this object is achieved by a method for producing a workpiece-side profile on a plastically deformable, preferably cylindrical, workpiece by axial forming,
wherein a forming process is carried out, during which a relative movement between a shaping tool profile provided on a forming tool and the workpiece to be formed is carried out to produce the workpiece-side profile having a workpiece-side profile length,
wherein, when the forming process is in progress,
an oscillating relative movement between the shaping tool profile and the workpiece to be formed is carried out during the relative movement between the shaping tool profile and the workpiece to be formed, in which oscillating relative movement a forming stroke and a return stroke in the opposite direction to the forming stroke are alternately carried out,
the shaping tool profile produces the workpiece-side profile on the workpiece with a partial length of the workpiece-side profile length during the forming stroke of the oscillating relative movement, and
the shaping tool profile moves during the return stroke of the oscillating relative movement along at least part of the partial length of the workpiece-side profile length produced during the preceding forming stroke,
   wherein, when the forming process is in progress, a variation is made with regard to the oscillating relative movement between the shaping tool profile and the workpiece to be formed.

The invention also relates to a mechanical arrangement having a forming machine which has a forming drive designed to carry out, during a forming process, a relative movement between a shaping tool profile provided on a forming tool of the forming machine and a workpiece, preferably a cylindrical workpiece, to be formed, in order to produce a workpiece-side profile having a workpiece-side profile length,
wherein a programmable numerical drive controller is provided for the forming drive, which is designed to control the forming drive by control parameters being storable in the drive controller, on the basis of which parameters an oscillating relative movement between the shaping tool profile and the workpiece to be formed is carried out when the forming process is in progress when the shaping tool profile moves relative to the workpiece to be formed, in which oscillating relative movement a forming stroke and a return stroke in the opposite direction to the forming stroke are alternately carried out,
wherein the shaping tool profile produces the workpiece-side profile on the workpiece with a partial length of the workpiece-side profile length during the forming stroke of the oscillating relative movement, and
wherein the shaping tool profile moves during the return stroke of the oscillating relative movement along at least part of the partial length of the workpiece-side profile length produced during the preceding forming stroke,
wherein the drive controller is designed to store control parameters for the forming process, on the basis of which parameters a variation is carried out when the forming process is in progress with regard to the oscillating relative movement between the shaping tool profile and the workpiece to be formed.

Accordingly, in the case of the invention, the forming process in progress varies with respect to the oscillating relative movement between the shaping tool profile and the workpiece to be formed, which movement is carried out to form the workpiece. A forming drive of the mechanical arrangement according to the invention, by means of which the forming tool, or the shaping tool profile, and the workpiece are moved relative to one another when the forming process is in progress, is provided with a drive controller, in particular a programmable numerical drive control, which accordingly controls the relative movement between the forming tool and the workpiece when the forming process is in progress. The manner in which the forming process in progress is varied on a case-by-case basis with respect to the oscillating relative movement of the shaping tool profile and the workpiece to be formed can in particular be determined in advance of a forming process and, in particular, empirically.

The workpiece to be machined preferably has a cylindrical shape and can be either a hollow body or solid. The present invention is particularly relevant for the automotive sector and, for example, for the production of shafts for vehicle drive trains within this sector.

In one embodiment, the forming process in progress is controlled by means of a programmable numerical controller. Control parameters are stored in the numerical controller and used as a basis for varying the forming process in progress with regard to the oscillating relative movement of the shaping tool profile and the workpiece to be formed in accordance with the particular application.

In a preferred embodiment of the method according to the invention, a previous forming process is followed by the aforementioned forming process as a further forming process. During the preceding forming process, an oscillating relative movement between the shaping tool profile and the workpiece to be formed is also carried out. In general, in the case of the invention, it is possible to use the same forming tool or forming tools of the same kind for the preceding forming process and for the further forming process.

If the actual geometry of the workpiece-side profile produced in the preceding forming process deviates from a target geometry of the workpiece-side profile, the further forming process in progress is varied, with respect to the oscillating relative movement between the shaping tool profile and the workpiece to be formed that is carried out during the further forming process, in such a way that the actual geometry of the workpiece-side profile produced as a result of the further forming process at least approximates the target geometry of the workpiece to be formed. Ideally, the variation of the further forming process in progress with respect to the oscillating relative movement of the shaping tool profile and the workpiece to be formed causes the actual geometry of the workpiece-side profile created during the further forming process to correspond to the target geometry of the workpiece-side profile.

Accordingly, the drive controller of the mechanical arrangement according to the invention provided for carrying out the method is designed to store control parameters for the forming process, on the basis of which parameters a variation is carried out during the further forming process in progress with regard to the oscillating relative movement between the shaping tool profile and the workpiece to be formed, as a result of which variation the actual geometry of the workpiece-side profile produced during the forming process corresponds to the target geometry of the workpiece-side profile or at least approximates the target geometry of the workpiece-side profile.

According to a development of the method according to the invention, both the preceding forming process and the further forming process are numerically controlled with respect to the oscillating relative movement between the shaping tool profile and the workpiece to be formed. The control parameters for the further forming process are defined in such a way that the further forming process is varied with respect to the oscillating relative movement between the shaping tool profile and the workpiece to be formed, as a result of which variation the deviation between the actual geometry and the target geometry of the workpiece-side profile that exists following the previous forming process is at least largely eliminated.

The deviation between the actual geometry and the target geometry of the workpiece profile following the previous forming process is determined and then serves as a basis for, for example, empirically determining the parameters used for varying the further forming process in progress with regard to the oscillating relative movement of the shaping tool profile and the workpiece to be formed.

Also in order to empirically determine the adjustments that are to be made during the further forming process in progress with regard to the oscillating relative movement between the forming tool and the workpiece to be formed, in a preferred embodiment of the invention, following the preceding forming process, the workpiece-side profile produced during the preceding forming process is measured, and then the actual geometry determined in this way for the workpiece-side profile produced in the preceding forming process is compared with the desired target geometry. As measuring devices conventional measuring devices can be used such as micrometer screws or measuring devices with measuring pins or measuring rollers. The comparison of the actual and the target geometries of the workpiece-side profile can be made using a conventional computer-aided comparison unit.

According to one embodiment, the invention provides that the preceding forming process in progress be uniform with regard to the oscillating relative movement between the shaping tool profile and the workpiece to be formed.

Alternatively, in a further embodiment of the invention, the preceding forming process in progress is also varied with respect to the oscillating relative movement between the shaping tool profile and the workpiece to be formed. In this case, the variation made during the further forming process in progress with respect to the oscillating relative movement between the shaping tool profile and the workpiece to be formed differs from the variation made when the preceding forming process is in progress.

According to the invention, the workpiece that has already been machined in the previous forming process could be re-machined in the further forming process. Alternatively, in a preferred variant of the method according to the invention, the preceding forming process is carried out as a trial forming process on a test workpiece, while the further forming process is carried out as a manufacturing process in which the workpiece-side profile is produced on a workpiece that is of the same kind as the test workpiece of the preceding forming process, preferably coming from the same batch as the sample workpiece.

In a further preferred variant of the invention, the method according to the invention and the mechanical arrangement according to the invention are designed to produce a workpiece-side toothing, wherein the workpiece-side toothing can, for example, be a straight toothing or a sloped toothing—for example, a toothing with a helical shape.

By means of appropriate designs of the mechanical arrangement according to the invention, external toothings or internal toothings can be produced. According to the invention, a forming die, for example, which sits on the workpiece to be formed, serves as the forming tool for producing external toothings. The workpiece can be solid or formed as a hollow body. According to the invention, internal toothings can be produced by means of a forming punch which engages in the wall of a workpiece-side cavity.

When producing a workpiece-side toothing, the actual geometry of the workpiece-side profile actually created in a previous forming process or the simulated actual geometry of a simulated workpiece-side profile is compared with the target geometry of the workpiece-side profile, preferably by comparing the actual angular position and the target angular position of a tooth trace and/or the actual shape and the target shape of a tooth trace. A total trace deviation can then, where applicable, be determined from a trace angle deviation and/or a trace shape deviation. For this purpose, gear measuring machines can be used as offered, for example, by the ZEISS group having its headquarter in Oberkochen, Germany. The total trace deviation can be used to determine in which way the further forming process or the forming process following the simulation is to be varied with regard to the oscillating relative movement between the shaping toothing profile and the workpiece to be formed, so that the machining result on the workpiece is a toothing with the desired toothing geometry.

In an advantageous embodiment of the method according to the invention, the variation carried out when the forming process is in progress and, where applicable, during the preceding forming process in progress with respect to the oscillating relative movement between the shaping tool profile and the workpiece to be formed is carried out on the basis of a process-relevant property of the workpiece to be formed, and thus in a workpiece-dependent manner.

A factor which experience has shown to have a significant effect on the machining result of a forming process of the type according to the invention, and which consequently represents a particularly process-relevant property of the workpiece to be formed, is the rigidity of the workpiece to be formed. In a preferred embodiment of the invention, the forming process in progress and, where applicable, the preceding forming process in progress are therefore varied as a function of the rigidity of the workpiece to be formed with respect to the oscillating relative movement between the shaping tool profile and the workpiece to be formed. The rigidity of a workpiece to be formed is determined, for example, by the material and/or the geometry of the workpiece. For example, in the case of workpieces designed as hollow bodies, the workpiece rigidity substantially depends upon the wall thickness of the workpiece and/or upon whether the workpiece has a blind hole or a penetrating cavity.

The material of the workpiece to be formed can also be relevant to the process irrespective of the effect it has on the workpiece rigidity and, in the case of the invention, induce an application-specific variation of the forming process in progress and, where applicable, of the preceding forming process in progress with respect to the oscillating relative movement. For example, the material of the workpiece to be formed affects the friction conditions during the relative movement carried out between the shaping tool profile and the workpiece to be formed for producing the workpiece-side profile.

The properties of a workpiece to be formed can vary in different regions. This may, for example, be due to internal stresses or differences in the structure that are caused by the manufacturing method of the workpiece blank. Deviations of the actual geometry of a workpiece-side profile from its target geometry resulting from such circumstances can also be avoided in the case of the invention by carrying out a variation, determined in particular empirically, of the oscillating relative movement between the shaping tool profile and the workpiece to be formed when a forming process is in progress and, where applicable, when a preceding forming process is in progress.

In addition or as an alternative to a workpiece-dependent variation, according to the invention, a variation that is dependent upon forming parameters can be carried out when a forming process is in progress and, where applicable, during a preceding forming process in progress with respect to the oscillating relative movement between the shaping tool profile and the workpiece to be formed. Such a forming parameter is, for example, the lubricant applied to the workpiece to be formed when the forming process is in progress and, where applicable, during the preceding forming process in progress.

Preferred measures according to the invention for varying the forming process in progress and, where applicable, the preceding forming process in progress with respect to the oscillating relative movement between the shaping tool profile and the workpiece to be formed are described as follows.

In a development of the invention, the size of the forming stroke and/or the size of the return stroke and/or the frequency of the oscillating relative movement between the shaping tool profile and the workpiece to be formed changes when the forming process is in progress and, where applicable, during the preceding forming process in progress.

In a variant of the method according to the invention, in which the forming process in progress and, where applicable, the preceding forming process in progress are varied, with respect to the oscillating relative movement between the shaping tool profile and the workpiece to be formed, by combining an oscillating relative movement with a unidirectional relative movement between the shaping tool profile and the workpiece to be formed, in accordance with the relevant application.

In the latter case, according to the invention, the shares of the oscillating relative movement and the unidirectional relative movement in the overall relative movement between the shaping tool profile and the workpiece to be formed and/or the temporal sequence of the oscillating relative movement and the unidirectional relative movement are variably defined.

In a further embodiment of the method according to the invention, the oscillating relative movement between the forming tool and the workpiece to be formed comprises a plurality of partial oscillating relative movements which are separated from one another by a unidirectional relative movement between the shaping tool profile and the workpiece to be formed. In order to vary the forming process in progress and, where applicable, the preceding forming process in progress with respect to the oscillating relative movement in an application-dependent manner, the procedure described above can be followed with respect to each of the partial oscillating relative movements.

### BRIEF DESCRIPTION OF THE DRAWINGS

Other objects and features of the invention will become apparent from the following detailed description considered in connection with the accompanying drawings. It is to be understood, however, that the drawings are designed as an illustration only and not as a definition of the limits of the invention.

In the drawings,

FIG. 1 shows a mechanical arrangement for producing a workpiece-side profile on a plastically deformable cylindrical workpiece by axial forming,

FIG. 2 shows a first possible way of designing a forming process on the mechanical arrangement according to FIG. 1, and

FIG. 3 shows a second possible way of designing a forming process on the mechanical arrangement according to FIG. 1.

### DETAILED DESCRIPTION OF PREFERRED EMBODIMENTS

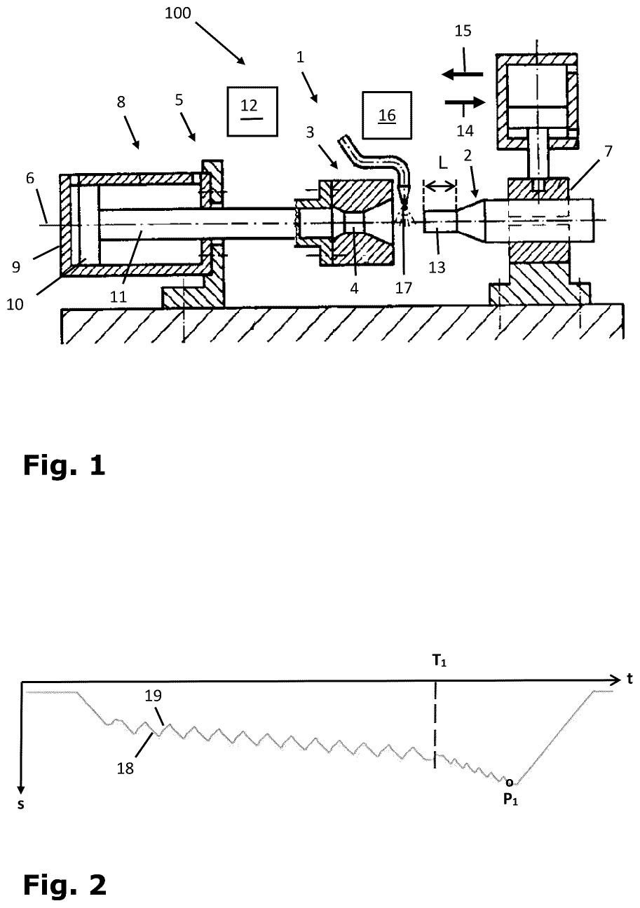

A mechanical arrangement 100 shown in FIG. 1 is designed to produce a profile in the form of a toothing profile designed as external toothing on a plastically deformable cylindrical workpiece—in this case, on a steel shaft blank 2 of a drive shaft for motor vehicles. As the forming tool, a forming machine 1 of the mechanical arrangement 100 comprises a conventional forming die 3, which has a shaping toothing profile (not shown in detail in FIG. 1) as the shaping tool profile in the region of a calibration section 4.

By means of a forming drive 5, the forming die 3 can be moved along a movement axis 6 relative to the shaft blank 2, which in turn is clamped by means of a clamping unit 7 and therefore does not move along the movement axis 6.

The forming drive 5 comprises a hydraulic piston-cylinder unit 8 having a stationary cylinder 9 and a piston 10 that is movably guided inside the cylinder 9 along the movement axis 6. At a piston rod 11, the piston-cylinder unit 8 is connected to the forming die 3. A programmable numerical controller in the form of a numerical drive controller 12, which is shown very schematically in FIG. 1, is provided for controlling the forming drive 5.

In the example shown, a shaft end 13 of reduced diameter of the shaft blank 2 is to be provided with a workpiece-side toothing profile having a workpiece-side profile length L by axial forming.

For this purpose, proceeding from the conditions according to FIG. 1, the forming die 3 is first fed unidirectionally along the movement axis 6 by means of the piston-cylinder unit 8 until the leading end of the calibration section 4, when viewed in the direction of movement, and thus the end of the shaping toothing profile provided on the forming die 3 that is the leading end when viewed in the direction of movement, runs onto the shaft end 13 of the shaft blank 2. The forming process now begins, during which the forming die 3 is fed further to the right in FIG. 1 relative to the shaft blank 2, but now by carrying out an oscillating movement of the forming die 3 relative to the shaft blank 2, this movement advancing to the right in FIG. 1, by appropriate control of the piston-cylinder unit 8 by means of the drive controller 12. During the oscillating relative movement between the forming die 3 and the shaping toothing profile on the one hand and the shaft blank 2 on the other, the shaping toothing profile alternately executes forming strokes in the direction of an arrow 14 and return strokes in the direction of an arrow 15, which is in the opposite direction to the forming strokes. During the forming strokes, the shaping toothing profile of the forming die 3 engages in the shaft end 13 to be formed and, by forming the shaft end 13, produces the workpiece-side toothing profile thereon with a partial length of the workpiece-side toothing length L. During the return strokes of the oscillating relative movement between the shaping toothing profile of the forming die 3 and the shaft blank 2, the shaping toothing profile moves each time in the opposite direction to the forming stroke along part of the partial length of the workpiece-side toothing length L produced during the previous forming stroke. By means of a lubricant supply 17 indicated in FIG. 1, lubricant is applied to the shaft blank 2 during the oscillating relative movement between the shaping toothing profile of the forming die 3 and the shaft blank 2.

By means of the numerical drive controller 12, the forming process in progress is varied with respect to the oscillating relative movement between the shaping toothing profile and the shaft blank 2 in accordance with the rigidity of the shaft blank 2 in the region of the shaft end 13 to be formed.

The manner in which the forming process in progress is varied with respect to the oscillating relative movement between the shaping toothing profile and the workpiece to be machined has been determined by appropriate programming of the drive controller 12 in advance of the forming process. The programmed process parameters were previously determined empirically by means of a trial preceding forming process.

For this purpose, after a trial forming process was carried out, the workpiece-side profile produced by the trial was measured by means of a measuring and evaluation device 16 of the mechanical arrangement 100, and the geometry of the workpiece-side profile produced by the trial was then compared with the desired target geometry. The measurement results, which are dependent upon the rigidity of the shaft blank in the region of the shaft end 13, then served as the basis for programming the drive controller 12 for the subsequent forming process performed as a further forming process.

A procedure that can be implemented by appropriate programming of the drive controller 12 of the mechanical arrangement 100 shown in FIG. 1 is illustrated in FIG. 2.

The graph shown in FIG. 2 shows the path s of the shaping toothing profile over time t. Downwardly directed flanks 18 of the sawtooth-like graph represent the forming strokes of the shaping toothing profile, and upwardly directed flanks 19 of the sawtooth-like graph illustrate the return strokes of the shaping toothing profile relative to the shaft blank 2. At a point P₁ the workpiece-side toothing length L is reached.

According to FIG. 2, in the example shown, due to correspondingly controlling the forming drive 5, the oscillating relative movement between the shaping toothing profile and the shaft blank 2 to be formed changes at a time T₁ in such a way that the size of the forming strokes and the size of the return strokes following the forming strokes are reduced, and the frequency of the oscillating relative movement between the shaping toothing profile and the shaft blank 2 to be formed is increased.

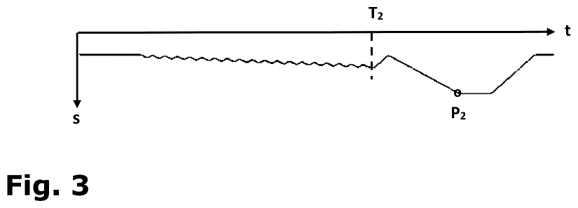

FIG. 3 shows a variation of the oscillating relative movement between the shaping toothing profile of the forming die 3 and a workpiece to be formed when a forming process is in progress, which differs from the conditions according to FIG. 2. In the application case according to FIG. 3, only a partial length of the workpiece-side profile length L is produced by means of an oscillating relative movement between the shaping toothing profile and the workpiece to be formed. At a time T₂, due to correspondingly controlling the forming drive 5 by means of the drive controller 12, the oscillating relative movement between the shaping toothing profile and the workpiece to be formed that has been carried out up to this point is terminated, and then a unidirectional forming movement of the shaping toothing profile relative to the workpiece to be formed is carried out until the workpiece-side toothing length L is reached at the point P₂.

Although only a few embodiments of the present invention have been shown and described, it is to be understood that many changes and modifications may be made thereunto without departing from the spirit and scope of the invention.

What is claimed is:

1. A method for producing a workpiece-side profile on a plastically deformable workpiece (2) by axial forming, comprising:
carrying out a forming process, during which a relative movement between a shaping tool profile provided on a forming tool (3) and the workpiece (2) to be formed is carried out to produce the workpiece-side profile having a workpiece-side profile length (L),
wherein, when the forming process is in progress,
an oscillating relative movement between the shaping tool profile and the workpiece (2) to be formed is carried out during the relative movement between the shaping tool profile and the workpiece (2) to be formed, in which oscillating relative movement a forming stroke and a return stroke in the opposite direction to the forming stroke are alternately carried out,
the shaping tool profile produces the workpiece-side profile on the workpiece (2) with a partial length of the workpiece-side profile length (L) during the forming stroke of the oscillating relative movement, and
the shaping tool profile moves during the return stroke of the oscillating relative movement along at least part of the partial length of the workpiece-side profile length (L) produced during the preceding forming stroke,
wherein, when the forming process is in progress, a variation is made with regard to the oscillating relative movement between the shaping tool profile and the workpiece (2) to be formed.

2. The method according to claim 1, wherein the forming process is controlled by a programmable numerical controller (12) in which control parameters are stored for carrying out the forming process, on the basis of which parameters the variation is made when the forming process is in progress with regard to the oscillating relative movement between the shaping tool profile and the workpiece (2) to be formed.

3. The method according to claim 1,
wherein the forming process is carried out after a preceding forming process, wherein a relative movement between a shaping tool profile provided on a forming tool (3) and a workpiece (2) to be formed is carried out during the preceding forming process in order to produce the workpiece-side profile with the workpiece-side profile length (L), wherein the forming tool (3) of the preceding forming process and the forming tool (3) of the forming process are of the same kind or identical, and wherein the workpiece (2) of the preceding forming process and the workpiece (2) of the forming process are of the same kind or identical,
wherein, when the preceding forming process was in progress,
an oscillating relative movement between the shaping tool profile and the workpiece (2) to be formed is carried out during the relative movement between the shaping tool profile and the workpiece (2) to be formed, in which oscillating relative movement a forming stroke and a return stroke in the opposite direction to the forming stroke are alternately carried out,
the shaping tool profile produces the workpiece-side profile on the workpiece (2) with a partial length of the workpiece-side profile length (L) during the forming stroke of the oscillating relative movement, and
the shaping tool profile moves during the return stroke of the oscillating relative movement along at least part of the partial length of the workpiece-side profile length (L) produced during the preceding forming stroke,
wherein, after completion of the preceding forming process, an actual geometry of the workpiece-side profile produced in the preceding forming process is determined and compared with a target geometry of the workpiece-side profile, and
wherein the forming process is carried out when the actual geometry of the workpiece-side profile produced in the preceding forming process deviates from the target geometry of the workpiece-side profile, wherein the variation with respect to the oscillating relative movement between the shaping tool profile and the workpiece (2) to be formed is made when the forming process is in progress such that the actual geometry of the workpiece-side profile produced in the forming process corresponds to the target geometry of the workpiece-side profile or at least approximates the target geometry of the workpiece-side profile.

4. The method according to claim 3,
wherein the preceding forming process is controlled by means of a numerical controller (12) in which control parameters for controlling the preceding forming process that was in progress with respect to the oscillating relative movement between the shaping tool profile and the workpiece (2) to be formed are stored, and
wherein the forming process is controlled by means of a programmable numerical controller (12) in which control parameters are stored for carrying out the forming process, on the basis of which a variation is made when the forming process is in progress with regard to the oscillating relative movement between the shaping tool profile and the workpiece (2) to be formed, due to which variation the actual geometry of the workpiece-side profile produced in the forming process corresponds to the target geometry of the workpiece-side profile or at least approximates the target geometry of the workpiece-side profile.

5. The method according to claim 3, wherein the actual geometry of the workpiece-side profile produced in the preceding forming process and the actual geometry of the workpiece-side profile produced in the forming process are determined by measuring the workpiece-side profile produced in the preceding forming process and the workpiece-side profile produced in the forming process.

6. The method according to claim 3, wherein the preceding forming process in progress is uniform with respect to the oscillating relative movement between the shaping tool profile and the workpiece (2) to be formed.

7. The method according to claim 3,
wherein, during the preceding forming process in progress, a variation is made with respect to the oscillating relative movement of the shaping tool profile and the workpiece (2) to be formed, and
wherein the variation made when the forming process is in progress with respect to the oscillating relative movement between the shaping tool profile and the workpiece (2) to be formed differs from the variation made in the preceding forming process in progress.

8. The method according to claim 3,
wherein the preceding forming process is carried out as a trial forming process in which the workpiece-side profile is produced on a test workpiece provided as the workpiece (2) to be formed, and
wherein the forming process is carried out as a manufacturing process in which the workpiece-side profile is produced on a workpiece (2) that is of the same kind as the test workpiece of the preceding forming process.

9. The method according to claim 1, wherein, during the forming process, a shaping toothing profile provided on the forming tool (3) as a shaping tool profile and the workpiece (2) to be formed are moved by means of the relative movement to produce a workpiece-side profile designed as a workpiece-side toothing profile having a workpiece-side toothing length as the workpiece-side profile length (L),
wherein the shaping toothing profile engages in the workpiece (2) to be formed during the forming stroke of the oscillating relative movement and produces the workpiece-side toothing profile on the workpiece (2) that has a partial length of the workpiece-side toothing length, and
wherein the shaping toothing profile moves during the return stroke of the oscillating relative movement along at least part of the partial length of the workpiece-side toothing length produced during the preceding forming stroke.

10. The method according to claim 1, wherein the variation carried out when the forming process is in progress with respect to the oscillating relative movement between the shaping tool profile and the workpiece (2) to be formed is carried out on the basis of a process-relevant property of the workpiece to be formed.

11. The method according to claim 10, wherein the variation carried out when the forming process is in progress with respect to the oscillating relative movement between the shaping tool profile and the workpiece (2) to be formed is carried out on the basis of a rigidity of the workpiece (2) to be formed.

12. The method according to claim 10, wherein the variation made when the forming process is in progress respect to the oscillating relative movement between the shaping tool profile and the workpiece (2) to be formed is carried out on the basis of a material of the workpiece (2) to be formed.

13. The method according to claim 1, wherein the variation carried out when the forming process is in progress with respect to the oscillating relative movement between the shaping tool profile and the workpiece (2) to be formed is carried out on the basis of at least one forming parameter.

14. The method according to claim 1, wherein the variation with respect to the oscillating relative movement between the shaping tool profile and the workpiece (2) to be formed is carried out when the forming process is in progress by varying the size of the forming stroke and/or the size of the return stroke and/or the frequency of the oscillating relative movement.

15. The method according to claim 1, wherein the variation with respect to the oscillating relative movement of the shaping tool profile and the workpiece (2) to be formed is carried out when the forming process is in progress by performing the oscillating relative movement as part of the relative movement of the shaping tool profile and the workpiece (2) to be formed and by performing a unidirectional relative movement between the shaping tool profile and the workpiece (2) to be formed in addition to the oscillating relative movement as a further part of the relative movement between the shaping tool profile and the workpiece (2) to be formed, wherein the shaping tool profile produces the workpiece-side profile on the workpiece (2) with a partial length of the workpiece-side profile length (L) during the unidirectional relative movement.

16. The method according to claim 15,
wherein the shares of the oscillating relative movement and the unidirectional relative movement in the relative movement between the shaping tool profile and the workpiece (2) to be formed are variably determined, and/or
wherein the order of the oscillating relative movement and the unidirectional relative movement is variably determined.

17. The method according to claim 15,
wherein the oscillating relative movement of the shaping tool profile and the workpiece (2) to be formed comprises a plurality of partial oscillating relative movements, wherein a unidirectional relative movement is carried out between two oscillating partial relative movements, and
wherein the variation with respect to the oscillating relative movement is carried out when the forming process is in progress by varying the forming process in progress and, where applicable, the preceding forming process in progress with respect to at least one of the partial oscillating relative movements.

18. The method according to claim 3,
wherein during the forming process and during the preceding forming process, a shaping toothing profile provided on the forming tool (3) as a shaping tool profile and the workpiece (2) to be formed are moved by means of the relative movement to produce a workpiece-side profile designed as a workpiece-side toothing profile having a workpiece-side toothing length as the workpiece-side profile length (L),
wherein the shaping toothing profile engages in the workpiece (2) to be formed during the forming stroke of the oscillating relative movement and produces the workpiece-side toothing profile on the workpiece (2) that has a partial length of the workpiece-side toothing length, and
wherein the shaping toothing profile moves during the return stroke of the oscillating relative movement along at least part of the partial length of the workpiece-side toothing length produced during the preceding forming stroke.

19. The method according to claim 3,
wherein the variation carried out when the forming process is in progress and, the variation carried out during the preceding forming process in progress with respect to the oscillating relative movement between the shaping tool profile and the workpiece (2) to be formed is carried out on the basis of a process-relevant property of the workpiece to be formed.

20. The method according to claim 3,
wherein the variation carried out when the forming process is in progress and the variation carried out during the preceding forming process in progress with respect to the oscillating relative movement between the shaping tool profile and the workpiece (2) to be formed is carried out on the basis of the rigidity of the workpiece (2) to be formed.

21. The method according to claim 3,
wherein the variation carried out when the forming process is in progress and the variation carried out during the preceding forming process in progress with respect to the oscillating relative movement between the shaping tool profile and the workpiece (2) to be formed is carried out on the basis of the rigidity of the workpiece (2) to be formed.

22. The method according to claim 3,
wherein the variation carried out when the forming process is in progress and the variation carried out during the preceding forming process in progress with respect to the oscillating relative movement between the shaping tool profile and the workpiece (2) to be formed is carried out on the basis of at least one forming parameter.

23. The method according to claim 3,
wherein the variation with respect to the oscillating relative movement between the shaping tool profile and the workpiece (2) to be formed is carried out when the forming process is in progress and during the preceding forming process in progress by varying the size of the forming stroke and/or the size of the return stroke and/or the frequency of the oscillating relative movement.

24. The method according to claim 3,
wherein the variation with respect to the oscillating relative movement of the shaping tool profile and the workpiece (2) to be formed is carried out when the forming process is in progress and during the preceding forming process in progress by performing the oscillating relative movement as part of the relative movement of the shaping tool profile and the workpiece (2) to be formed and by performing a unidirectional relative movement between the shaping tool profile and the workpiece (2) to be formed in addition to the oscillating relative movement as a further part of the relative movement between the shaping tool profile and the workpiece (2) to be formed, wherein the shaping tool profile produces the workpiece-side profile on the workpiece (2) with a partial length of the workpiece-side profile length (L) during the unidirectional relative movement.

25. The method according to claim 24,
wherein the shares of the oscillating relative movement and the unidirectional relative movement in the relative movement between the shaping tool profile and the workpiece (2) to be formed are variably determined, and/or
wherein the order of the oscillating relative movement and the unidirectional relative movement is variably determined.

26. The method according to claim 24,
wherein the oscillating relative movement of the shaping tool profile and the workpiece (2) to be formed comprises a plurality of partial oscillating relative movements, wherein a unidirectional relative movement is carried out between two oscillating partial relative movements, and
wherein the variation with respect to the oscillating relative movement is carried out when the forming process is in progress and during the preceding forming process in progress by varying the forming process in progress and the preceding forming process in progress with respect to at least one of the partial oscillating relative movements.

27. A mechanical arrangement for producing a workpiece-side profile on a plastically deformable workpiece (2) by axial forming, comprising:
a forming machine (1) which has a forming drive (5) designed to carry out, during a forming process, a relative movement between a shaping tool profile provided on a forming tool (3) of the forming machine (1) and a workpiece (2) to be formed, in order to produce a workpiece-side profile having a workpiece-side profile length (L),
a programmable numerical drive controller (12) for the forming drive (5), which is designed to control the forming drive (5) by control parameters being storable in the drive controller (12), on the basis of which parameters an oscillating relative movement between the shaping tool profile and the workpiece (2) to be formed is carried out when the forming process is in progress when the shaping tool profile moves relative to the workpiece (2) to be formed, in which oscillating relative movement a forming stroke and a return stroke in the opposite direction to the forming stroke are alternately carried out,
wherein the shaping tool profile produces the workpiece-side profile on the workpiece (2) with a partial length of the workpiece-side profile length (L) during the forming stroke of the oscillating relative movement, and
wherein the shaping tool profile moves during the return stroke of the oscillating relative movement along at least part of the partial length of the workpiece-side profile length (L) produced during the preceding forming stroke, and
wherein the drive controller (12) is designed to store control parameters for the forming process, on the basis of which parameters a variation is carried out when the forming process is in progress with regard to the oscillating relative movement between the shaping tool profile and the workpiece (2) to be formed.

28. The mechanical arrangement according to claim 27,
wherein the forming drive (5) of the forming machine (1) is designed to carry out the forming process after a preceding forming process and to perform a relative movement between a shaping tool profile provided on a forming tool (3) of the forming machine (1) and a workpiece (2) to be formed during the preceding forming process in order to produce the workpiece-side profile having the workpiece-side profile length (L), wherein the forming tool (3) of the preceding forming process and the forming tool (3) of the forming process are of the same kind or identical, and wherein the workpiece (2) of the preceding forming process and the workpiece (2) of the forming process are of the same kind or identical,
wherein the drive controller (12) is designed to control the forming drive (5) by control parameters being storable in the drive controller (12), on the basis of which parameters, when the preceding forming process is in progress, an oscillating relative movement between the shaping tool profile and the workpiece (2) to be formed is performed during the relative movement between the shaping tool profile and the workpiece (2) to be formed, in which oscillating relative movement a forming stroke and a return stroke in the opposite direction to the forming stroke are alternately carried out,
wherein the shaping tool profile produces the workpiece-side profile on the workpiece (2) with a partial length of the workpiece-side profile length (L) during the forming stroke of the oscillating relative movement, and
wherein the shaping tool profile moves during the return stroke of the oscillating relative movement along at least part of the partial length of the workpiece-side profile length (L) produced during the preceding forming stroke,
wherein a measuring and evaluation device (16) is provided, by means of which, after completion of the preceding forming process, an actual geometry of the workpiece-side profile produced during the preceding forming process can be determined and compared with a target geometry of the workpiece-side profile, wherein the forming process is carried out by means of the forming machine (1) if the actual geometry of the workpiece-side profile produced during the preceding forming process deviates from the target geometry of the workpiece-side profile,
and
wherein the drive controller (12) is designed to store control parameters for the forming process, on the basis of which control parameters a variation is made when the forming process is in progress with regard to the oscillating relative movement between the shaping tool profile and the workpiece (2) to be formed, due to which variation the actual geometry of the workpiece-side profile produced during the forming process corresponds to the target geometry of the workpiece-side profile or at least approximates the target geometry of the workpiece-side profile.
